(19) United States
(12) Patent Application Publication
(10) Pub. No.: US 2018/0060923 A1
(43) Pub. Date: Mar. 1, 2018

(54) SERVER DEVICE, PROCESSING METHOD OF SERVER DEVICE, AND PROGRAM

(71) Applicant: NEC Personal Computers, Ltd., Tokyo (JP)

(72) Inventors: Hiroshi Nakaji, Tokyo (JP); Shougo Abe, Tokyo (JP)

(73) Assignee: NEC Personal Computers, Ltd., Tokyo (JP)

(21) Appl. No.: 15/669,027

(22) Filed: Aug. 4, 2017

(30) Foreign Application Priority Data
Aug. 30, 2016 (JP) 2016168576

(51) Int. Cl. G06Q 30/02; G06F 17/30

(52) U.S. Cl. CPC G06Q 30/0277; G06F 17/30867

(57) ABSTRACT

To readily identify a document to which an advertisement is desired to be attached and to reduce the burden on an advertisement submitter, a server device is provided in an advertisement providing system including an advertisement submitter terminal for inputting an advertisement, a user terminal for displaying articles, wherein the server device causes the user terminal to display an advertisement with an article. The server device includes a transmitting unit transmitting information specifying a plurality of candidate articles to the advertisement submitter terminal to display the candidate articles, a receiving unit receiving from the advertisement submitter terminal information specifying at least one candidate article selected from the plurality of the candidate articles, and a sending unit sending the advertisement to the user terminal when an article similar to the selected candidate article is displayed in the user terminal, to display the advertisement on the user terminal with the similar article.

### FIELD OF THE INVENTION

The present invention relates to a server device, a processing method of a server device, and a program.

### BACKGROUND OF THE INVENTION

Online advertising means have been developing continuously since the spread of public use of the Internet. Recently, there has even appeared a system that displays an advertisement after calculating matching between a webpage to which an advertisement is attached and the advertisement to be attached. There are roughly two types of such matching calculations. One compares a webpage with the content of an advertisement. The other computes the statistics actually measured between a webpage and an advertisement. Herein, a description will be made particularly about the former type of matching.

To enable comparison between a webpage and the content of an advertisement, it is necessary to describe the content of the advertisement at the time of placing the advertisement. Google Ads and other systems allow designation of keywords when placing an advertisement. In the advertisement system of Google Ads, the display of an advertisement is determined according to the balance between the presence or absence of a keyword on a webpage and the advertising budget. A technique achieving more accurate matching between a webpage and an advertisement by allowing input of sentences rather than keywords at the time of placing an advertisement has also been put to practical use (for example, Patent Document 2).

According to Patent Document 2, content matching with high accuracy is enabled through automatic extraction of search terms from a webpage to which an advertisement is to be attached, searching an advertisement database using the search terms, and re-matching the search results.

Patent Document 1 discloses an advertisement information sharing system which aims at allowing anyone to easily post an article with an advertisement added thereto and, by presenting an advertisement attracting attention of readers of the article, making it possible to further encourage the posting of advertisement-added articles by contributors and also further promote the browsing and utilization of the advertisements by the readers. In this system, when a user logs in his/her own personalized page from a user terminal such as a mobile terminal or a computer connected to an advertisement information sharing server via a network, and uses a posting form on the personalized page to input article information such as a title and text of description of an article that the user would like to post, advertisement information that matches the content of the article based on the keyword(s) obtained from the input article information is presented to the user, and, according to the selection by the user, the advertisement information matching the content of the article is added to the article information.

[Patent Document 1] Japanese Patent No. 5636082

[Patent Document 2] Japanese Patent Application Laid-Open No. 2015-154195

### SUMMARY OF THE INVENTION

In the case of using the advertisement system as described in Patent Document 2 to efficiently achieve good advertising results, it is necessary to adjust the descriptive text when submitting an advertisement. That is, it would be necessary to carefully consider the descriptive text so that it resembles the articles that would be preferred by users who use the products of the advertiser. This task imposes a large burden on the advertiser or the advertisement submitter who is not a professional writer. Even if the advertiser or the advertisement submitter is good at writing, it would be more difficult to presume the style of writing of writers of the webpages on which an advertisement is to be placed or take into consideration the matching logic of the system.

Namely, as in the case of the SEO (search engine optimization; technique of configuring a webpage such that it will be ranked higher in the search results) for a Web search system, it is necessary to make the advertisement conform to the system described in Patent Document 2 or to the description of the webpage on which the advertisement is to be placed. Further, it is desirable that the advertisement submission system can support a submitter so that he/she can utilize the system sufficiently even if he/she is not a professional writer.

With the technique described in Patent Document 1, a unit configured to automatically select an advertisement that is suitable for an article on a homepage opened by a user is provided, which can lessen the burden for the user to select an advertisement and can facilitate the user posting of an advertisement-added article. This however is a technique of reducing the burden on the user who wishes to place an advertisement on the user's own homepage or the like; it does not contribute to reduction of the burden on an advertisement submitter who submits an advertisement for a product that will appear in product listing ads.

The present invention has been accomplished in view of the conventional problems as described above, with an object to provide, in a system which analyzes a document and displays a product advertisement related to the words used in the document, a server device, a processing method of a server device, and a program that make it readily possible to identify a document to which an advertisement is desired to be inserted and that can also reduce the burden on the advertisement submitter.

To solve the above problems, a server device is a server device in an advertisement providing system including an advertisement submitter terminal for an advertisement submitter to input an advertisement, a user terminal for a user to read articles, and a server device causing an advertisement to be displayed on the user terminal together with an article read by the user, the server device including: a transmitting unit that transmits information specifying a plurality of candidate articles to the advertisement submitter terminal to cause the candidate articles to be displayed on the advertisement submitter terminal; a receiving unit that receives from the advertisement submitter terminal information specifying at least one candidate article selected from the plurality of candidate articles displayed on the advertisement submitter terminal; and a sending unit that sends the advertisement to the user terminal in a case where an article similar to the selected candidate article is read in the user terminal, to cause the advertisement to be displayed on the user terminal together with the similar article.

To also solve the above problems, a server device is a server device in an advertisement providing system including an advertisement submitter terminal for an advertisement submitter to input an advertisement, a user terminal for a user to read articles, and a server device causing an advertisement to be displayed on the user terminal together with an article read by the user, the server device including: an instructing unit that instructs the advertisement submitter terminal to display a search screen to allow the advertisement submitter to search a plurality of articles for an article related to the advertisement; a search word receiving unit that receives a search word input to the search screen by the advertisement submitter; a searching unit that searches the plurality of articles for a plurality of candidate articles on the basis of the search word; a transmitting unit that transmits information specifying the plurality of candidate articles searched for to the advertisement submitter terminal, to cause the candidate articles to be displayed on the advertisement submitter terminal; a receiving unit that receives from the advertisement submitter terminal information specifying at least one candidate article selected from the plurality of candidate articles displayed on the advertisement submitter terminal; and a sending unit that sends the advertisement to the user terminal in a case where an article similar to the selected candidate article is read in the user terminal, to cause the advertisement to be displayed on the user terminal together with the similar article.

Further, to solve the above problems, another server device is a server device in an advertisement providing system including an advertisement submitter terminal for an advertisement submitter to input an advertisement, a user terminal for a user to read articles, and a server device causing an advertisement to be displayed on the user terminal together with an article read by the user, the server device including: a transmitting unit that transmits information specifying a plurality of candidate articles to the advertisement submitter terminal to cause the candidate articles to be displayed on the advertisement submitter terminal; a receiving unit that receives from the advertisement submitter terminal information specifying at least one candidate article selected from the plurality of candidate articles displayed on the advertisement submitter terminal; and a sending unit that sends the advertisement to the user terminal in a case where the selected candidate article is read in the user terminal, to cause the advertisement to be displayed on the user terminal together with the article.

### Effects of the Invention

According to the present invention, it is possible to obtain, in the system which analyzes a document and displays a product advertisement related to the words used in the document, the server device, the processing method of the server device, and the program that make it readily possible to identify a document to which an advertisement is desired to be inserted and that can also reduce the burden on the advertisement submitter.

### BRIEF DESCRIPTION OF THE DRAWINGS

FIG. 1 shows an overall configuration of an advertisement providing system that includes an intermediate server in an embodiment of the present invention;

FIG. 2 illustrates an example of the hardware configuration of the RSS server, the advertisement submitter terminal, the intermediate server, and the user terminal constituting the advertisement providing system including the intermediate server in the present embodiment;

FIG. 3 is a block diagram illustrating examples of the functions of the intermediate server in the present embodiment;

FIG. 4 shows a submission screen used for submitting an advertisement from the advertisement submitter terminal that accesses the intermediate server in the present embodiment, illustrating the screen state prior to selection of an article to which the advertisement is to be attached;

FIG. 5 shows the submission screen used for submitting an advertisement from the advertisement submitter terminal that accesses the intermediate server in the present embodiment, illustrating the screen state prior to searching for an article to which the advertisement is to be attached;

FIG. 6 shows the submission screen used for submitting an advertisement from the advertisement submitter terminal that accesses the intermediate server in the present embodiment, illustrating the screen state after searching for an article to which the advertisement is to be attached;

FIG. 7 shows the submission screen used for submitting an advertisement from the advertisement submitter terminal that accesses the intermediate server in the present embodiment, illustrating the screen state when confirming keywords for the article to which the advertisement is to be attached;

FIG. 8 shows the submission screen used for submitting an advertisement from the advertisement submitter terminal that accesses the intermediate server in the present embodiment, illustrating the screen state after selecting the article to which the advertisement is to be attached;

FIG. 9 illustrates the state of crawled articles stored in the intermediate server in the present embodiment;

FIG. 10 illustrates the association between product advertisements and identifiers stored in the intermediate server after the articles to which the advertisements are to be attached are selected in the advertisement submitter terminal that accesses the intermediate server in the present embodiment;

FIG. 11 is a flowchart illustrating an operation of the advertisement providing system including the intermediate server in the present embodiment;

FIG. 12 shows an overall configuration of a conventional advertisement providing system; and

FIG. 13 illustrates, by way of example, content of advertisement submission displayed on a screen of the advertisement submitter terminal that accesses the intermediate server in the conventional advertisement providing system.

### DETAILED DESCRIPTION OF THE INVENTION

An embodiment for carrying out the present invention will be described below in detail with reference to the drawings. In the drawings, the same or corresponding parts are denoted by the same symbols, and duplicate descriptions thereof will be simplified or omitted as appropriate. While the embodiment will be described below, the present invention is not limited to the embodiment described. Although an advertisement providing system having an RSS server, an intermediate server, an advertisement submitter terminal, and a user terminal is described as a specific example in the following embodiment, the present invention is also applicable to an advertisement providing system that includes more than one RSS server, more than one intermediate server, more than one advertisement submitter terminal, and more than one user terminal. Further, in the following description, products to be advertised include, not only the products which are independent objects of commercial transactions, but also services as well as novelties accompanying the purchased products or services.

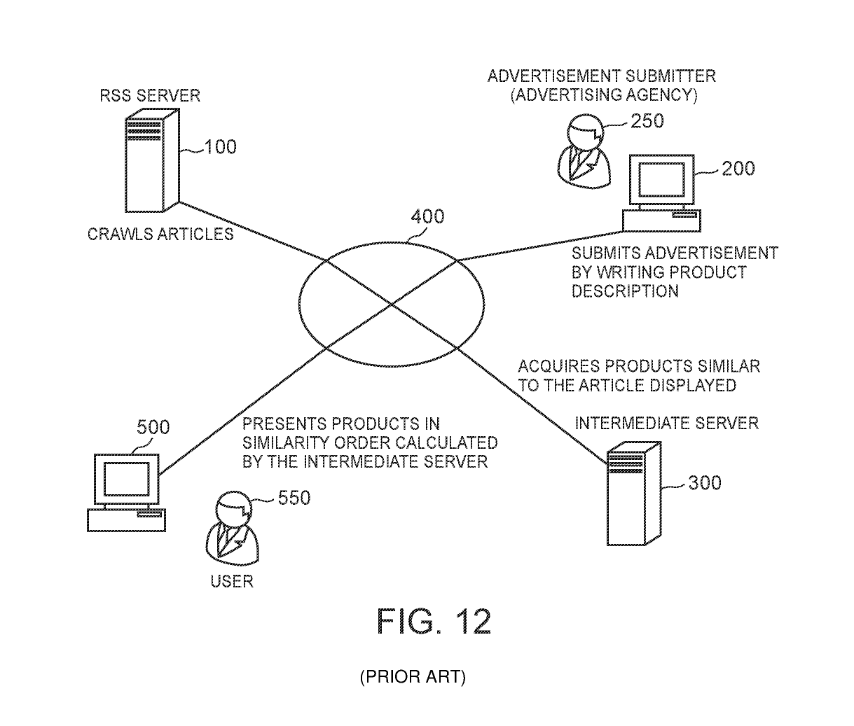

Firstly, an overall configuration of a conventional advertisement providing system will be described. FIG. 12 shows the overall configuration of a conventional advertisement providing system.

In FIG. 12, a rich site summary (RSS) server 100, an advertisement submitter terminal 200, an intermediate server 300, and a user terminal 500 are communicably connected to each other via a network 400. The network 400 may be the Internet connection, by way of example, although it may be a network connection other than the Internet.

The RSS server 100 is a server that acquires RSS, or, extensible Markup Language (XML) format documents for describing site summaries. The server crawls distributed articles through XML links, RSS links, and other links in the news sites and blogs. Crawling refers to a task, performed by a crawler introduced by a search engine, of visiting websites on the Web and registering the webpages on a database or an index. The crawler follows the links on the webpages to collect information on the sites, and registers newly updated pages as well as update information of existing pages on the index, for reflecting them to the search results.

The advertisement submitter terminal 200 is a terminal used by an advertisement submitter 250 in an advertising agency to submit a product advertisement using various terms and expressions on the basis of a descriptive text of a product requested from an advertiser (not shown), such that the advertisement is selected by the intermediate server 300 as an advertisement to be placed on the article(s) crawled by the RSS server 100.

The intermediate server 300 is a server that reads an article crawled by the RSS server 100, and selects, from among the advertisements submitted from the advertisement submitter terminal 200, any advertisement that is similar to the article or any advertisement that is to be placed on the article, to thereby acquire an advertisement similar to the article displayed on the user terminal 500.

The user terminal 500 is a terminal that displays, on a screen, search results calculated by the intermediate server 300 as product information.

It should be noted that the RSS server 100 and the intermediate server 300 may each be any device having information processing functions as long as it can serve as a server having the above-described functions. For example, the RSS server 100 and the intermediate server 300 may be integrated into a single device. That is, when it is configured such that an advertisement is acquired by the intermediate server 300 directly from a script of the article page distributed by an external Web server, then it is not an essential requirement for the RSS server 100 to have the function of distributing articles. Further, while the advertisement submitter terminal 200 and the user terminal 500 are described as personal computers (hereinafter, also referred to as PCs) by way of example, they may be any devices having information processing functions as long as they have the above-described functions. The above descriptions also apply to an advertisement providing system including an intermediate server in the present embodiment, which will be described later.

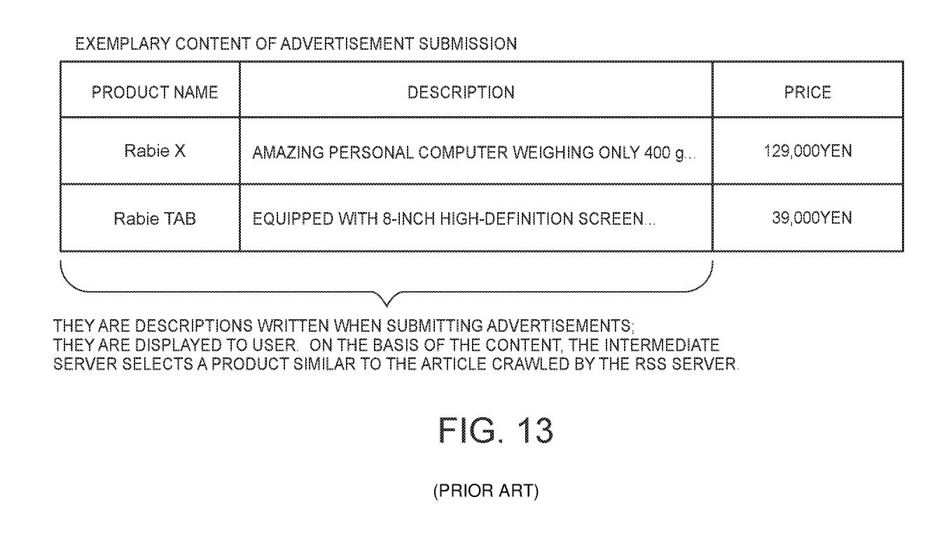

A description will now be made about an example of content of advertisement submission displayed on a screen of the advertisement submitter terminal that accesses the intermediate server in the conventional advertisement providing system. FIG. 13 illustrates, by way of example, the content of advertisement submission displayed on a screen of the advertisement submitter terminal that accesses the intermediate server in the conventional advertisement providing system.

For example, consider a case where an advertiser, who is a manufacturer that manufactures and sells PCs, asks an advertisement submitter 250 in an advertising agency to create advertising copies for PCs. At this time, assume that the advertisement submitter 250 describes, as the advertising copies input to the advertisement submitter terminal 200, information regarding the products, such as product names, product descriptions, and prices of the PCs, as shown as exemplary content of advertisement submission in FIG. 13. On the basis of these advertising copies, the intermediate server 300 selects a product similar to the article crawled by the RSS server 100.

Returning to FIG. 12, the user terminal 500 presents, to the user 550, products as the search results obtained based on a search word input from the user 550, in an order of similarity calculated by the intermediate server 300 on the basis of the search word.

Namely, typical ways of using words are calculated using crawled articles and stored in advance. When a new article is input, it is determined which word in the new article is a distinctive word, as compared to the typical ways of using words stored in advance. Further, the distinctive word is used to search EC sites to obtain a product, and it is determined whether there is a similarity between the crawled article and the product by taking account of general information again. The advertisement for the product is then placed.

As such, in the conventional advertisement providing system, there is a problem that the products to be displayed on the user terminal 500 as the search results are determined in accordance with a determination, made by the intermediate server 300, as to whether there is a similarity between the advertising copy (information regarding the product) input by the advertisement submitter 250 in the advertising agency to the advertisement submitter terminal 200 and the article crawled by the RSS server 100, i.e. whether the advertising copy (information regarding the product) includes keywords searched for more often by the search engine. In other words, there is a risk that the correlation between the terms included in the advertising copy and the words searched for by the search engine determines whether or not the product advertisement will be displayed on the user terminal 500.

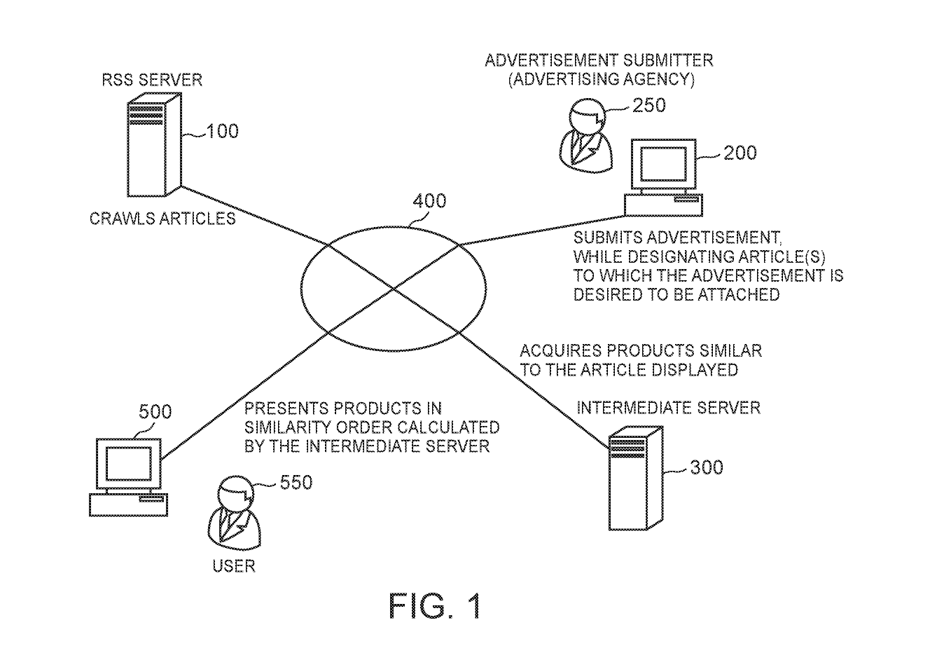

An overall configuration of an advertisement providing system including an intermediate server in the present embodiment will now be described. FIG. 1 shows an overall configuration of the advertisement providing system including the intermediate server in the present embodiment.

In FIG. 1, an RSS server 100, an advertisement submitter terminal 200, an intermediate server 300, and a user terminal 500 are communicably connected to each other via a network 400. This configuration is identical to the overall configuration of the conventional advertisement providing system described in conjunction with FIG. 12 above, so their differences will primarily be described below. The network 400 may be the Internet connection, by way of example, although it may of course be a network connection other than the Internet.

The inventive system differs from the conventional advertisement providing system in that the content that an advertisement submitter 250 in an advertising agency submits using the advertisement submitter terminal 200 is not an advertising copy (information regarding the product); rather, the advertisement submitter 250 submits an advertisement while designating an article to which he/she wishes to add the advertisement, from a list of the articles crawled by the RSS server 100. This will be described later in detail.

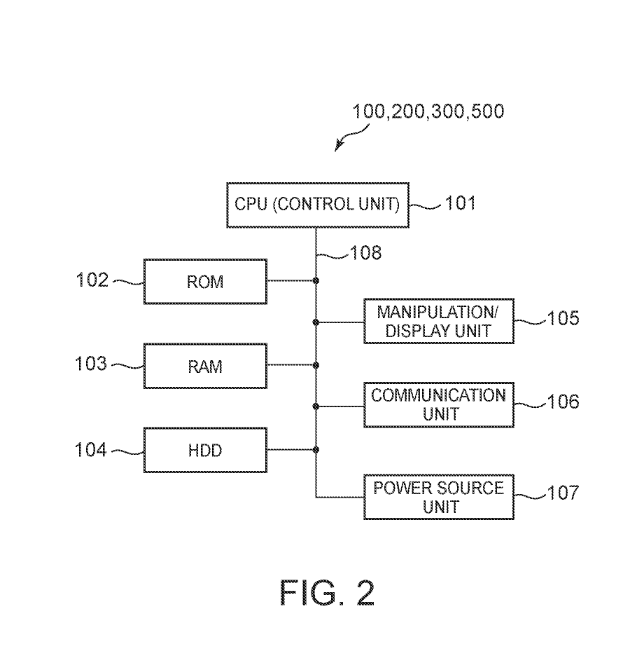

An example of a hardware configuration of the RSS server, the advertisement submitter terminal, the intermediate server, and the user terminal constituting the advertisement providing system including the intermediate server in the present embodiment will now be described. FIG. 2 illustrates an example of the hardware configuration of the RSS server, the advertisement submitter terminal, the intermediate server, and the user terminal constituting the advertisement providing system including the intermediate server in the present embodiment.

In FIG. 2, servers functioning as the RSS server 100 and the intermediate server 300, and PCs functioning as the advertisement submitter terminal 200 and the user terminal 500 in the present embodiment each include, as the hardware configuration, a central processing unit (CPU) (control unit) 101 which controls overall operations of the server or the PC. It also includes storage units, such as a read only memory (ROM) 102 and a random access memory (RAM) 103, which store various data and programs. It further includes a power source unit 107 which supplies power to the server or the PC.

The server or the PC further includes a manipulation/display unit 105 which has a function allowing a user of the server or the PC to manipulate the server or the PC using a keyboard, a touch panel made up of a liquid crystal display (LCD), or the like, and a function of displaying data etc. stored in the ROM 102 and the RAM 103 of the server or the PC. It also includes a communication unit 106 for the server or the PC to communicate with an externally provided server or PC via the network 400. It further includes a hard disk drive (HDD) 104 which stores an application program installed into the server or the PC.

The CPU 101, the ROM 102, the RAM 103, the HDD 104, the manipulation/display unit 105, the communication unit 106, and the power source unit 107 are connected via a bus 108. Various processing in the server or the PC is implemented as the CPU 101 loads and executes various programs stored in the ROM 102 and the RAM 103, although not limited thereto, these functions may be implemented using individual hardware circuits, etc.

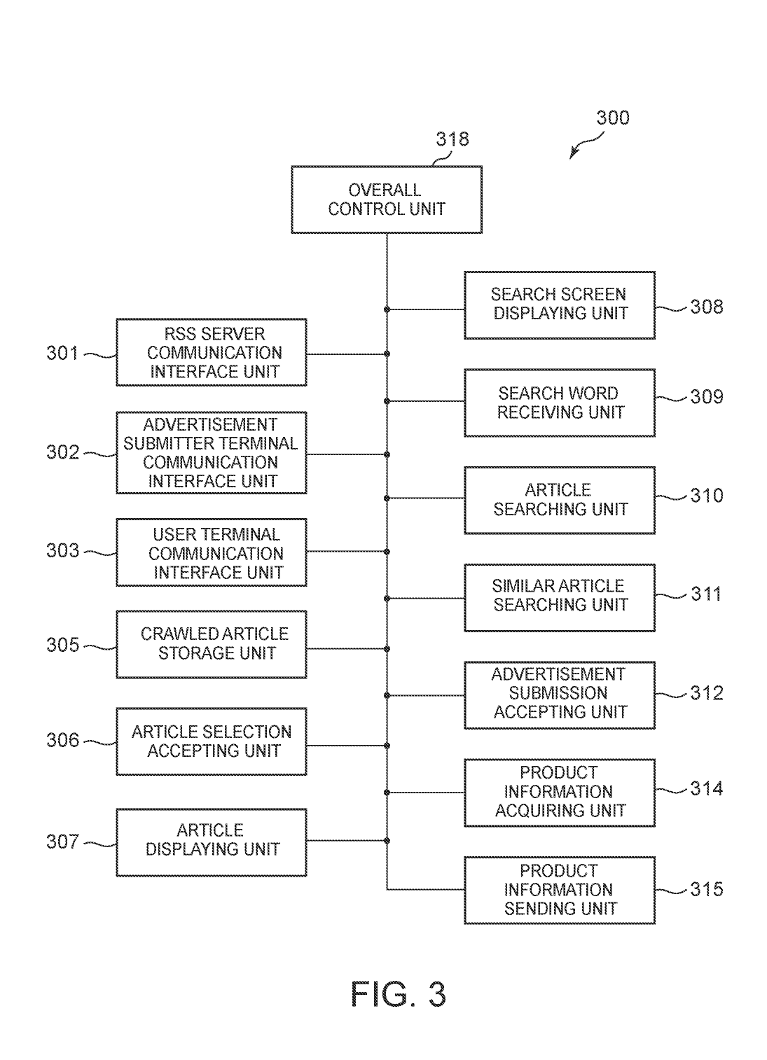

Examples of functions of the intermediate server in the present embodiment will now be described. FIG. 3 is a block diagram illustrating examples of the functions of the intermediate server in the present embodiment.

In FIG. 3, an RSS server communication interface unit 301 communicates with the RSS server 100 via the network 400. An advertisement submitter terminal communication interface unit 302 communicates with the advertisement submitter terminal 200 via the network 400. A user terminal communication interface unit 303 communicates with the user terminal 500 via the network 400. It should be noted that the RSS server communication interface unit 301, the advertisement submitter terminal communication interface unit 302, and the user terminal communication interface unit 303 may communicate with the network 400 in a wired or wireless manner.

A crawled article storage unit 305 stores an article crawled by the RSS server 100, in association with an article ID that is automatically applied to the crawled article upon crawling by the RSS server 100. Further, the crawled article storage unit 305 stores association between a product advertisement (information regarding the product) input by the advertisement submitter 250 and an article, on the basis of the article ID. An article selection accepting unit 306 accepts an article that is selected by the advertisement submitter 250 using the advertisement submitter terminal 200. While the article ID is described in the present embodiment as an identifier that identifies a crawled article, any other identifier may be used as long as it can identify an article.

An article displaying unit 307 displays, on a screen of the advertisement submitter terminal 200, candidate articles obtained on the basis of a search word, input by the advertisement submitter 250, indicating the characteristic of the product to be advertised. A search screen displaying unit 308 displays, on the advertisement submitter terminal 200, a search screen for accepting an input of a search word, so as to accept from the advertisement submitter 250 the search word indicating the characteristic of the product to be advertised. A search word receiving unit 309 accepts the search word input to the search screen on the advertisement submitter terminal 200. An article searching unit 310 searches the articles stored in the crawled article storage unit 305, on the basis of the search word, for candidate articles related to the characteristic of the product to be advertised. The article searching unit 310 also has a function of, in the case where a keyword indicating the content of a certain article among the candidate articles once retrieved by the article searching unit 310 on the basis of the search word is a distinctive keyword that indicates the characteristic of the product more appropriately than the initially input search word, searching the articles stored in the crawled article storage unit 305 again by using that distinctive keyword, input by the advertisement submitter 250, as a search word.

A similar article searching unit 311 is operable, in response to an instruction to search the articles stored in the crawled article storage unit 305 for an article similar to a certain candidate article obtained on the basis of a search word, to perform similarity search to identify any candidate article similar to the certain article. An advertisement submission accepting unit 312 accepts submission of a product advertisement (information regarding the product such as the product name, product description, etc.) that the advertisement submitter 250 inputs using the advertisement submitter terminal 200.

A product information acquiring unit 314 acquires an article stored in the crawled article storage unit 305 on the basis of the article ID applied to the article accepted by the article selection accepting unit 306, and also acquires a product advertisement accepted by the advertisement submission accepting unit 312, on the basis of that article ID. A product information sending unit 315 sends a product advertisement, acquired by the product information acquiring unit 314, to any article similar to the article being displayed on the user terminal 500, in an order of similarity to the product obtained by calculation. An overall control unit 318 performs overall control of the blocks constituting the intermediate server 300.

There are many ways of obtaining articles similar to the article being displayed on the user terminal 500. In the present embodiment, any one of those methods may be used. For example, there is a method of classifying articles and searching for articles by using a technique of extracting a keyword based on two indices of term frequency (TF) and inverse document frequency (IDF), and tagging. Further, a technique of tagging focusing on relevance between articles may be used, in which case cosine similarity may be used on collected articles to measure the similarity between the articles, to obtain distances between the articles. Further, there also is a method of using these calculated results to create a plurality of clusters, to thereby collect only the highly relevant articles.

Further, the RSS server communication interface unit 301, the advertisement submitter terminal communication interface unit 302, the user terminal communication interface unit 303, the crawled article storage unit 305, the article selection accepting unit 306, the article displaying unit 307, the article searching unit 310, the similar article searching unit 311, the advertisement submission accepting unit 312, the product information acquiring unit 314, and the product information sending unit 315 are connected via a bus 317.

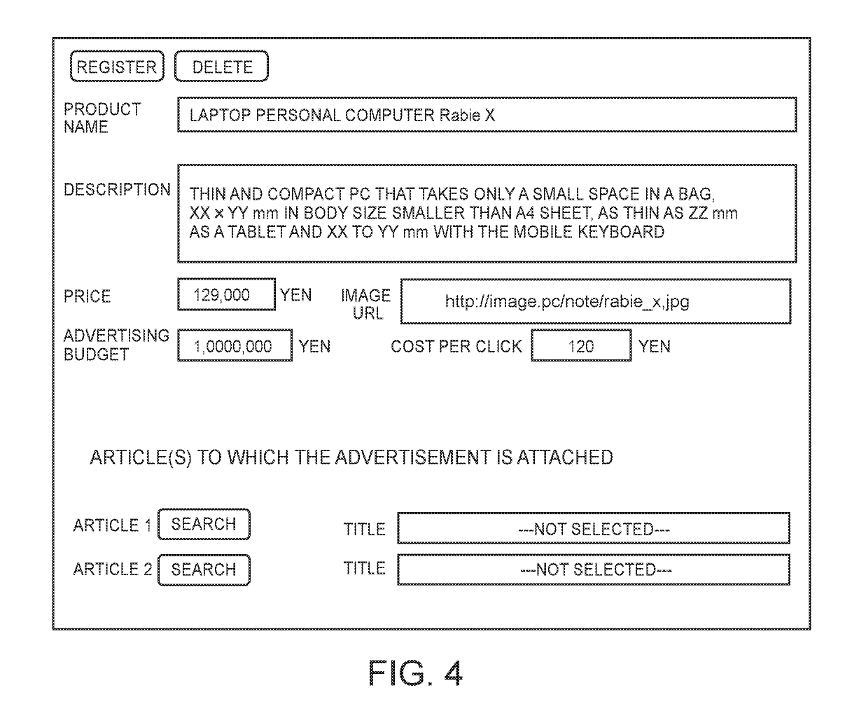

A description will now be made, for a submission screen used for submitting an advertisement from an advertisement submitter terminal that accesses the intermediate server in the present embodiment, about the screen state before an article to which an advertisement is to be attached is selected. FIG. 4 shows a submission screen used for submitting an advertisement from an advertisement submitter terminal that accesses the intermediate server in the present embodiment, illustrating the screen state prior to selection of an article to which the advertisement is to be attached. As used herein, “attaching” an advertisement means that, when a user 550 manipulates a user terminal 500 to search for a certain product or service, an advertisement related to the product or service is displayed along with the screen display of the product or service searched for. The advertisement may be displayed in any display manner.

In FIG. 4, it is assumed that the advertisement submitter 250 has been requested to submit an advertisement for a product named “Laptop Personal Computer Rabie X” from an advertiser (not shown). The advertisement submitter 250 inputs, on the advertisement submission screen on the advertisement submitter terminal 200, “Laptop Personal Computer Rabie X” as the product name, and “thin and compact PC that takes only a small space in a bag, XX×YY mm in body size smaller than A4 sheet, as thin as ZZ mm as a tablet and XX to YY mm with the mobile keyboard” as the product description. The submitter also inputs, on the same screen, the price, the advertising budget, the uniform resource locator (URL) where the product image is stored, and the cost per click paid by the advertiser to the advertising agency for one click by a user.

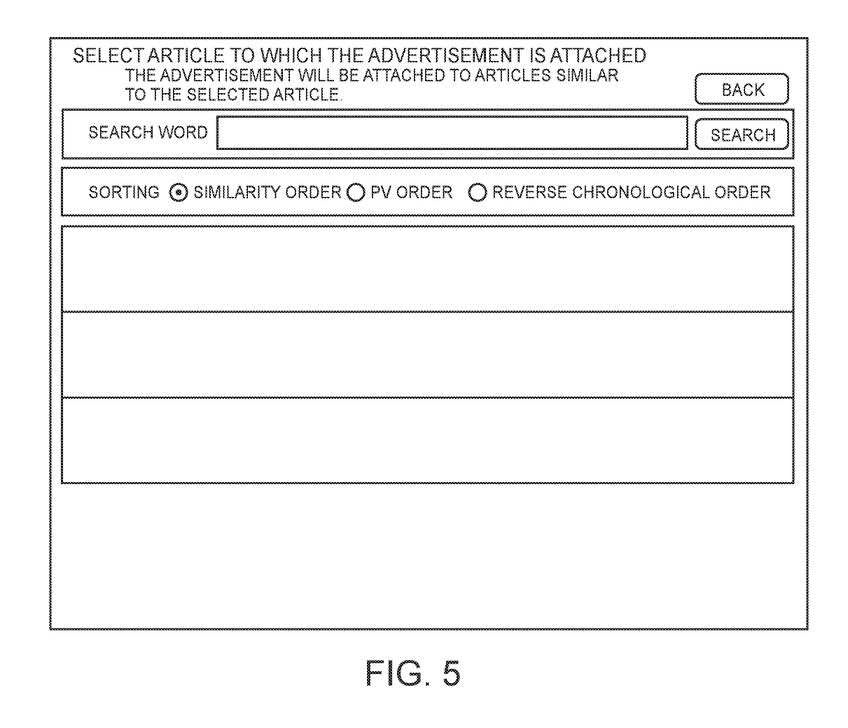

A description will now be made, for the submission screen used for submitting an advertisement from the advertisement submitter terminal that accesses the intermediate server in the present embodiment, about the screen state before an article to which the advertisement is to be attached is searched for. FIG. 5 shows the submission screen used for submitting an advertisement from the advertisement submitter terminal that accesses the intermediate server in the present embodiment, illustrating the screen state prior to searching for an article to which the advertisement is to be attached.

When the “Search” button for “Article 1” in the field of “Article(s) to which the advertisement is attached” in the lower part of FIG. 4 is selected in the advertisement submitter terminal 200, the intermediate server 300 instructs the advertisement submitter terminal 200 to display the search screen in FIG. 5 on the screen of the terminal. The top line in FIG. 5 reads: “Select article to which the advertisement is attached”. When a search word is input to the “Search word” field and the “Search” button to the right is selected, candidate articles are displayed as search results, in the blank field in the lower part, while being sorted in an order of similarity to the search word input. When one of the articles displayed in the lower part is selected, the product advertisement that the advertisement submitter 250 is intended to attach will be placed on articles similar to the selected article.

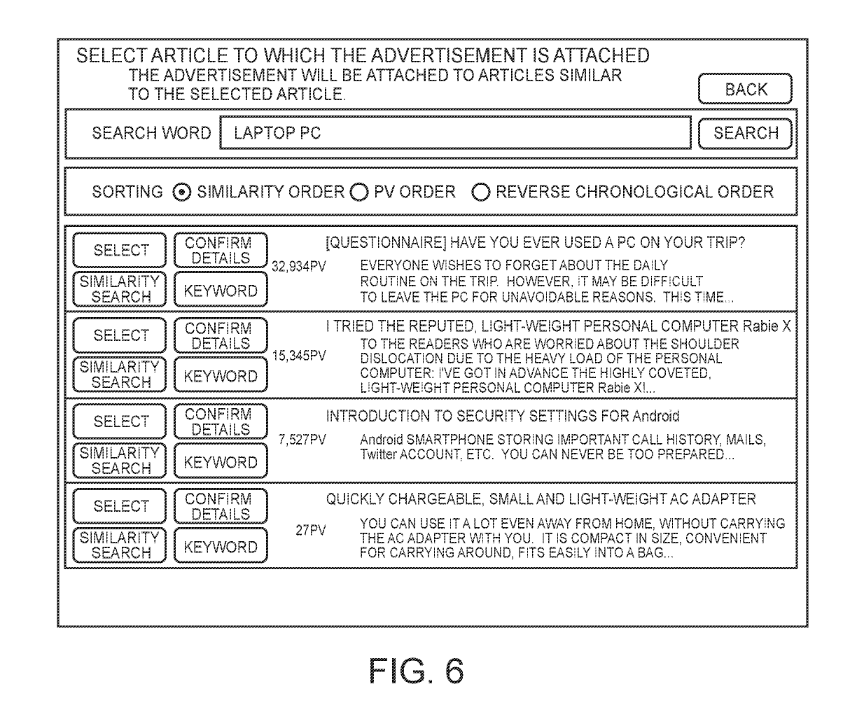

A description will now be made, for the submission screen used for submitting an advertisement from the advertisement submitter terminal that accesses the intermediate server in the present embodiment, about the screen state after an article to which the advertisement is to be attached is searched for. FIG. 6 shows the submission screen used for submitting an advertisement from the advertisement submitter terminal that accesses the intermediate server in the present embodiment, illustrating the screen state after searching for an article to which the advertisement is to be attached.

In FIG. 6, “Laptop PC” has been input to the “Search word” field and the “Search” button has been selected, and as a result, candidate articles retrieved using the search word “Laptop PC” are sorted in the similarity order, and titles and parts of the texts are displayed. For example, in FIG. 6, when the “Select” button is selected from among the buttons arranged to the left of the candidate article that has been determined to be most similar to the search word, then the product advertisement that the advertisement submitter 250 is intended to attach will be placed on articles similar to the selected, candidate article. When the “Keyword” button is selected, the keywords unique to that article are displayed.

While the titles and parts of the texts of the candidate articles sorted in the order of similarity to the search word have been displayed in FIG. 6, the search results may be displayed in a page view (PV) order, i.e. order of view frequency of the candidate articles, or in a reverse chronological order, i.e. descending order of the posted date and time of the candidate articles. Further, the words to be input as the search words may be ambiguous as compared to the conventional case where the advertisements would be attached only on the basis of the information regarding the products.

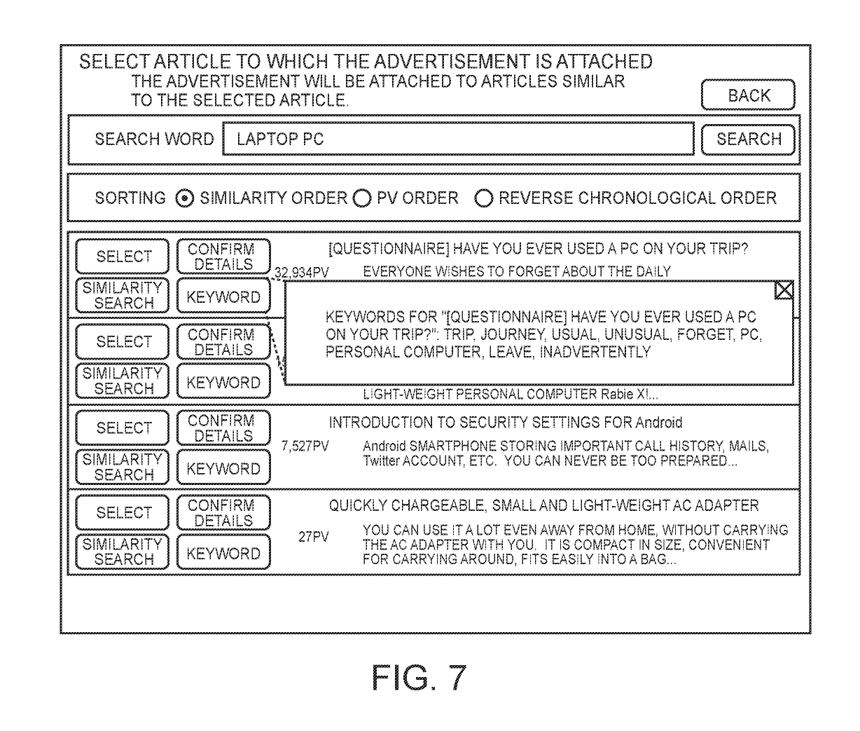

A description will now be made, for the submission screen used for submitting an advertisement from the advertisement submitter terminal that accesses the intermediate server in the present embodiment, about the screen state when keywords for the article to which the advertisement is to be attached are confirmed. FIG. 7 shows the submission screen used for submitting an advertisement from the advertisement submitter terminal that accesses the intermediate server in the present embodiment, illustrating the screen state when confirming the keywords for the article to which the advertisement is to be attached.

In FIG. 7, for example when a mouse pointer is placed over the “Keyword” button to the left of the candidate article (titled: [Questionnaire] Have you ever used a PC on your trip?) that has been determined to be most similar to the search word “Laptop PC”, the keywords (trip, journey, usual, unusual, forget, PC, personal computer, leave, inadvertently) representing the features of the article appear as a popup for display. When the keywords being displayed include any keyword that clearly expresses the feature of the product for which it is desired to attach the advertisement, then that keyword may be used for retrying the search, as will be described later.

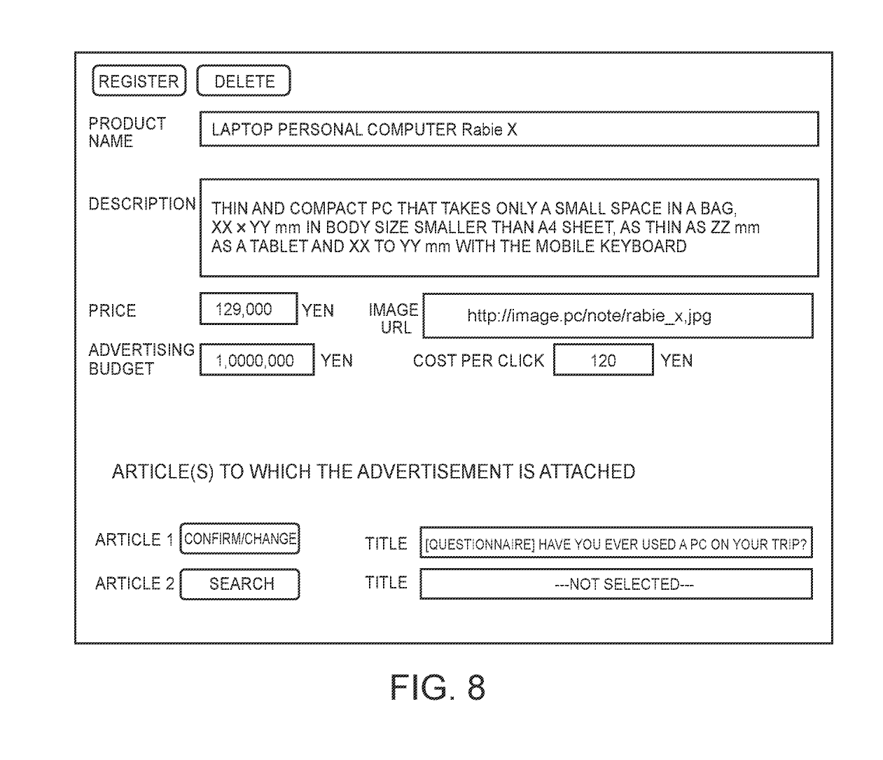

A description will now be made, for the submission screen used for submitting an advertisement from the advertisement submitter terminal that accesses the intermediate server in the present embodiment, about the screen state after an article to which the advertisement is to be attached is selected. FIG. 8 shows the submission screen used for submitting an advertisement from the advertisement submitter terminal that accesses the intermediate server in the present embodiment, illustrating the screen state after selecting the article to which the advertisement is to be attached.

Referring to FIG. 8, in the submission screen described in conjunction with FIG. 4 used for submitting an advertisement from the advertisement submitter terminal 200 that accesses the intermediate server 300, the title of the article that has been selected by pressing the “Select” button in FIG. 6 is input to the right of “Article 1” in the field of “Article(s) to which the advertisement is attached” in the lower part. FIG. 8 shows the case where the candidate article displayed at the top in FIG. 6 has been selected. When the “Confirm/Change” button for the “Article 1” for which the “Title” has been input is selected, the screen returns to the screen state before searching for an article to which the advertisement is to be attached, in the submission screen used for submitting the advertisement from the advertisement submitter terminal 200 described in conjunction with FIG. 5. In the above-described manner, the advertisement submitter 250 is able to select an article to which an advertisement for the target product is to be attached.

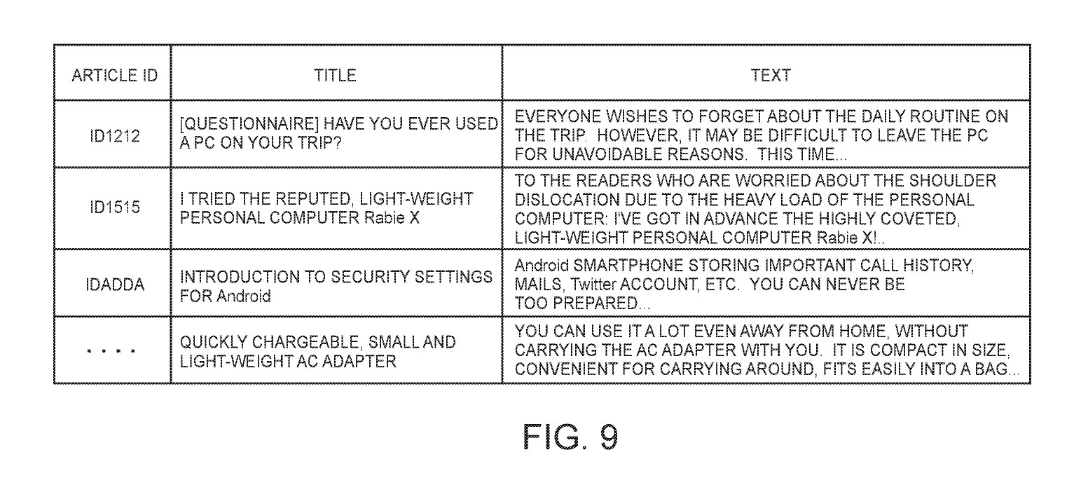

A description will now be made about the state of crawled articles which are stored in the intermediate server in the present embodiment. FIG. 9 illustrates the state of the crawled articles stored in the intermediate server in the present embodiment.

The intermediate server 300 stores, in the crawled article storage unit 305, the articles crawled by the RSS server 100 and the article IDs automatically applied to the articles while being crawled, in association with each other. FIG. 9 illustrates the state where article texts, article titles, and article IDs are associated with each other, and these article texts, article titles, and article IDs are stored in the associated state in the crawled article storage unit 305.

Even in a case where a new product is released, it is likely that the articles including the content related to the characteristics of the product are similar in substance. Therefore, even in such a case where a new product is released, there is no particular need to change the article IDs if it is configured to select an article similar to the article including the content related to the characteristics of the product.

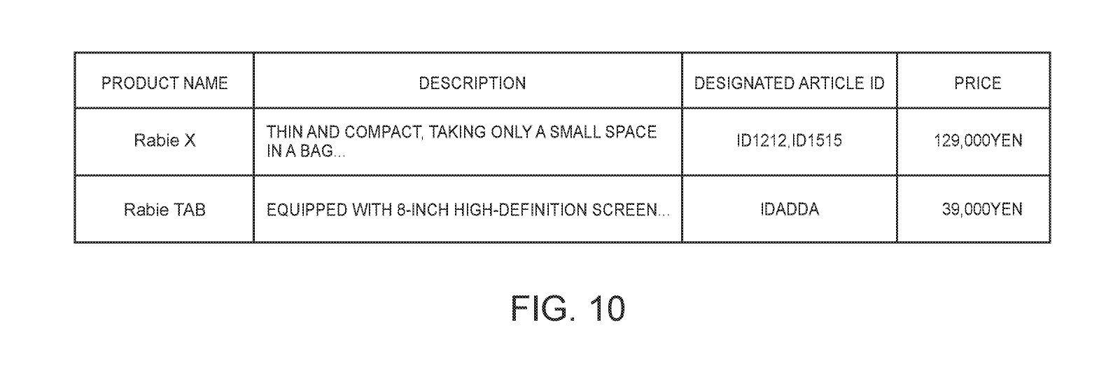

A description will now be made about the association of a product advertisement with an identifier, which is stored in the intermediate server after an article to which an advertisement is to be attached is selected in the advertisement submitter terminal that accesses the intermediate server in the present embodiment. FIG. 10 illustrates the association between the product advertisements and the identifiers stored in the intermediate server after the articles to which the advertisements are to be attached are selected in the advertisement submitter terminal that accesses the intermediate server in the present embodiment.

As explained above, when the advertisement submitter 250 uses the advertisement submitter terminal 200 to submit a product advertisement for a PC (information regarding the product such as product name, description of the product, and price) and further select an article to which the product advertisement is to be attached, from the list of candidate articles, displayed on the screen of the advertisement submitter terminal 200, with the titles and texts associated with each other as described in conjunction with FIG. 6, then the screen is changed to the screen in FIG. 8.

Then, as shown in FIG. 10, for the PC having the product name “Rabie X”, the article ID “1212” is written in addition to the information regarding the product including the product description reading “thin and compact, taking only a small space in a bag . . . ” and the price “129,000 yen”. This indicates that the advertisement for the product named “Rabie X” will be placed on an article similar to the text reading “Everyone wishes to forget about the daily routine on the trip. However, it may be difficult to leave the PC for unavoidable reasons. This time . . . ” titled “[Questionnaire] Have you ever used a PC on your trip?” corresponding to the article ID “1212” explained in conjunction with FIG. 9.

Similarly, for the PC having the product name “Rabie X”, the article ID “1515” is written in addition to the information regarding the product including the product description reading “thin and compact, taking only a small space in a bag . . . ” and the price “129,000 yen”. This indicates that the advertisement for the product named “Rabie X” will be placed on an article similar to the text reading “To the readers who are worried about the shoulder dislocation due to the heavy load of the personal computer: I've got in advance the highly coveted, light-weight personal computer Rabie X! . . . ” titled “I tried the reputed, light-weight personal computer Rabie X” corresponding to the article ID “1515” explained in conjunction with FIG. 9.

Further, for the PC having the product name “Rabie TAB”, the article ID “ADDA” is written in addition to the information regarding the product including the product description reading “equipped with 8-inch high-definition screen” and the price “39,000 yen”. This indicates that the advertisement for the product named “Rabie TAB” will be placed on an article similar to the text reading “Android smartphone storing important call history, mails, Twitter (registered trademark) account, etc. You can never be too prepared . . . ” corresponding to the article ID “ADDA” explained in conjunction with FIG. 9.

It is unnecessary for the article ID itself to be displayed in such a manner that the advertisement submitter 250 can see the ID on the screen of the advertisement submitter terminal 200. The article ID may be linked to the target product at the time when the screen is switched from the one shown in FIG. 6 to the one shown in FIG. 8, i.e. at the time point when the article to which the advertisement for the target product is to be attached is selected, as explained above.

In the above embodiment, it is configured such that a product advertisement for a PC (information regarding the product including the product name, product description, and price) is submitted and then an article is designated, so that the advertisement for the PC is attached to an article similar to the text of that article. Alternatively, it may be configured such that, of the product advertisement for the PC (information regarding the product including the product name, product description, and price), the minimum required information like the product name is submitted and then an article is designated, so that the advertisement for the PC is attached to an article similar to the text of that article. In this case, the title and the text of the article may be taken into consideration when searching for an article similar to the text of the article.

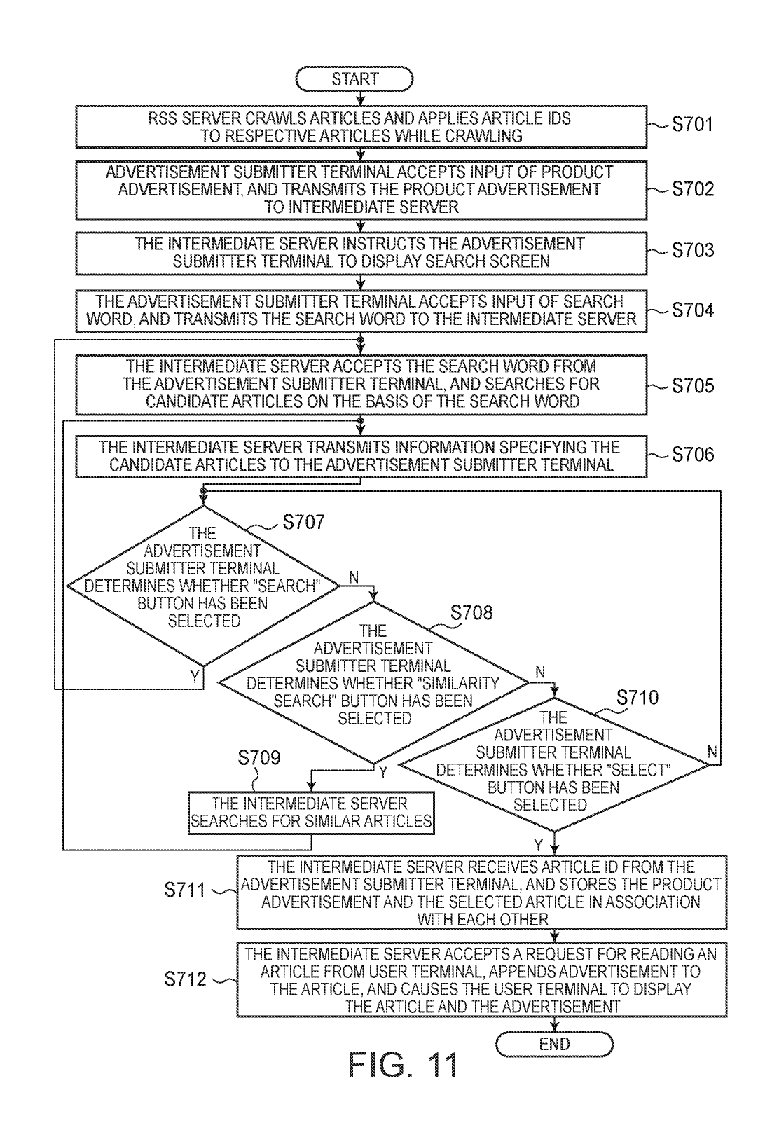

An operation of the advertisement providing system including the intermediate server in the present embodiment will now be described. FIG. 11 is a flowchart illustrating the operation of the advertisement providing system including the intermediate server in the present embodiment.

In FIG. 11, firstly, in the process in step S701, the RSS server 100 crawls articles. The RSS server 100 applies article IDs to the respective articles while crawling. The intermediate server 300 stores, in the crawled article storage unit 305, the article text, the article title, and the article ID, in association with each other.

Next, in the process in step S702, the advertisement submitter terminal 200 accepts an input of a product advertisement (information regarding the product, such as the product name, product description, and price) for the product to be advertised, and transmits the product advertisement information to the intermediate server 300. It should be noted that the product advertisement information transmitted to the intermediate server 300 is accepted in the advertisement submission accepting unit 312 and used by the product information acquiring unit 314 in step S711, which will be described later. The advertisement submitter 250 is able to transmit to the intermediate server 300 a search request for an article to which the advertisement is to be attached, by selecting the “Search” button on the submission screen in FIG. 4. When the article search request is accepted, in the process in step S703, the search screen displaying unit 308 of the intermediate server 300 instructs the advertisement submitter terminal 200 to display the search screen in FIG. 5 on the screen of the terminal.

Next, in the process in step S704, the advertisement submitter terminal 200 accepts an input of a search word to the “Search word” field in FIG. 5 and, when accepting selection of the “Search” button, transmits the input search word to the intermediate server 300. In the process in step S705, the search word receiving unit 309 in the intermediate server 300 accepts the search word, and the article searching unit 310 searches for candidate articles on the basis of the search word. The article searching unit 310 in the intermediate server 300 searches the articles stored in the crawled article storage unit 305 for candidate articles on the basis of the search word. In the process in step S706, the article displaying unit 307 in the intermediate server 300 transmits information specifying the candidate articles retrieved by the article searching unit 310, to the advertisement submitter terminal 200. At this time, the intermediate server 300 causes a list of the candidate articles to be displayed on the screen of the advertisement submitter terminal 200 in a certain order, for example in the order of similarity to the search word, in the page view (PV) order, or in the reverse chronological order. Further, the intermediate server 300 extracts, from the candidate articles, keywords used for searching for the articles and representing the features of the respective articles, and causes the information regarding the keywords representing the features of the respective articles to be displayed as well on the screen of the advertisement submitter terminal 200.

Next, the advertisement submitter 250 can determine whether the keywords representing the features of a certain article among the list of the articles (texts) displayed on the screen of the advertisement submitter terminal 200 include any distinctive keyword that indicates the characteristic of the product more appropriately. When determining that there is such a distinctive keyword, the advertisement submitter 250 can input a desired keyword, among the keywords representing the features of the article displayed (FIG. 7), into the “Search word” field and then select the “Search” button, for execution of the search again. In the process in step S707, the advertisement submitter terminal 200 determines whether the “Search” button has been selected, and if so, the advertisement submitter terminal 200 transmits to the intermediate server 300 a request for search using the distinctive keyword input to the “Search word” field (“Y” in step S707). Then, the process in step S705 is performed again, where the intermediate server 300 searches the articles.

On the other hand, if a request for search using the distinctive keyword is not transmitted to the intermediate server 300 (“N” in step S707), the process proceeds to the process in step S708. The advertisement submitter 250 can select a “Similarity search” button if the submitter desires a search for articles similar to a given article displayed on the screen of the advertisement submitter terminal 200. In the process in step S708, the advertisement submitter terminal 200 determines whether a “Similarity search” button has been selected, and if so, the advertisement submitter terminal 200 transmits a search request for similar articles to the intermediate server 300 (“Y” in step S708).

In the process in step S709, the intermediate server 300 searches the articles stored in the crawled article storage unit 305 for any article similar to the article corresponding to the selected “Similarity search” button. This search for similar articles is performed by the similar article searching unit 311 in the intermediate server 300. The similar article searching unit 311 extracts the similar articles found, as new candidate articles. When the similar articles are extracted as new candidate articles in the intermediate server 300, again in the process in step S706, the article displaying unit 307 transmits information specifying the candidate articles extracted by the similar article searching unit 311, to the advertisement submitter terminal 200.

If a search request for similar articles is not transmitted to the intermediate server 300 (“N” in step S708), the process proceeds to the process in step S710. The advertisement submitter 250 can select an article to which the advertisement for a target product is to be attached, from the list of candidate articles displayed on the screen of the advertisement submitter terminal 200. In the process in step S710, the advertisement submitter terminal 200 determines whether a “Select” button has been selected. If a “Select” button has been selected (“Y” in step S710), the advertisement submitter terminal 200 transmits the article ID identifying the selected article, to the intermediate server 300, thereby requesting registration of the selected article. In the process in step S711, the article selection accepting unit 306 in the intermediate server 300 receives the article ID from the advertisement submitter terminal 200 to thereby accept the selection of the article. The crawled article storage unit 305 stores the product advertisement information accepted by the product information acquiring unit 314 and the article ID of the selected article, in association with each other.

In the process in step S712, the intermediate server 300 accepts a request for reading an article from a user terminal 500, appends an advertisement to the article, and causes the user terminal 500 to display the article and the advertisement. When accepting a request for reading an article from the user terminal 500, the intermediate server 300 searches for the article ID from the crawled article storage unit 305, and selects the product advertisement being associated with that article ID, as the product advertisement to be appended to the article. At this time, as similar articles have been associated with the product advertisement through the above steps, the same product advertisement can be displayed also in the case of displaying the similar article on the user terminal 500. In the case where more than one product advertisement is associated with a same article ID, the product advertisements are displayed successively in an order according to a given rule. For example, the order of similarity between an article and a product may be obtained through calculations, in which case the different product advertisements are appended to the article in the order of the similarity. It may be configured such that a product advertisement to be appended is changed in succession among the different product advertisements, at regular time intervals, or each time the article is read. The article with the product advertisement appended thereto is sent to the terminal 500 by the product information sending unit 315 in the intermediate server 300.

While the present embodiment specifically describes the advertisement providing system that selects an article to which the advertisement submitter 250 wishes to attach a product advertisement, from among the articles crawled by the RSS server 100, the present invention is not limited to the embodiment. It may be configured such that a server that distributes articles is logically separate from the intermediate server 300. That is, the user terminal 500 receives an article page from a Web server, and transmits information containing a script specifying the article, to the intermediate server 300. The intermediate server 300 searches for an article similar to the specified article. The intermediate server 300 identifies an advertisement for which the similar article is designated, and responds to the above script. The script then displays the identified advertisement on the user terminal 500. With this configuration, the operation is possible even in the case where a Web server exists separately from the RSS server 100 or is integrated with the intermediate server 300.

Further, while the present embodiment specifically describes the advertisement providing system that searches for articles on the basis of a search word input by the advertisement submitter 250 using the advertisement submitter terminal 200 and selects, from the retrieved articles, an article to which the advertisement submitter 250 wishes to attach a product advertisement, the present invention is not limited to the embodiment.

That is, the intermediate server 300 may store candidate articles designated by the advertisement submitter 250, and, when the advertisement submitter 250 is to select candidate articles again for another advertisement, the intermediate server 300 may allow him/her to select the articles from the history. This can further reduce the burden on the advertisement submitter 250 during the task of submitting an advertisement requested from an advertiser who repeatedly requests the submission of advertisements.

As described above, in the present embodiment, it is configured such that an article to which an advertisement may be desired to be attached is selected from among the articles searched for using a search word, and when an article similar to that article is displayed to a user, the product advertisement is displayed together. With this, it becomes possible to appeal the product even to user groups other than those conventionally considered as the appealing targets, by adding the product advertisement even to articles that are similar to the article having an image of user groups who may seem irrelevant to the product at a glance but to whom the appealing targets may be desirably expanded.

As such, according to the present invention, it is possible to obtain, in the system that analyzes a document and displays a product advertisement related to the words included in the document, the server device, the processing method of the server device, and the program that make it readily possible to identify a document to which an advertisement is desired to be inserted and that can also reduce the burden on the advertisement submitter.

While the embodiment of the present invention has been described above, the embodiment of the present invention is not limited thereto. Specifically, other embodiments as well as additions, modifications, deletions, etc. are possible within the range conceivable by those skilled in the art, and any such embodiments are within the scope of the present invention as long as they can exert the functions and effects of the present invention.

We claim:

1. A server device in an advertisement providing system including an advertisement submitter terminal for an advertisement submitter to input an advertisement, a user terminal for a user to read articles, wherein the server device causes an advertisement to be displayed on the user terminal together with an article read by the user, the server device comprising:
a transmitting unit that transmits information specifying a plurality of candidate articles to the advertisement submitter terminal, to cause the candidate articles to be displayed on the advertisement submitter terminal;
a receiving unit that receives from the advertisement submitter terminal information specifying at least one candidate article selected from the plurality of candidate articles displayed on the advertisement submitter terminal; and
a sending unit that sends the advertisement to the user terminal when an article similar to the selected candidate article is read in the user terminal, to cause the advertisement to be displayed on the user terminal together with the similar article.

2. The server device according to claim 1, wherein:
the plurality of candidate articles are each stored in a storage unit in an identifiable state, and
when the receiving unit receives the information specifying the selected candidate article from the advertisement submitter terminal, the storage unit stores an article corresponding to the information specifying the selected candidate article and the advertisement in association with each other.

3. The server device according to claim 1, further comprising a similar article searching unit that searches for an article similar to a prescribed candidate article among selected candidate articles.

4. A server device in an advertisement providing system including an advertisement submitter terminal for an advertisement submitter to input an advertisement, a user terminal for a user to read articles, wherein the server device causes an advertisement to be displayed on the user terminal together with an article read by the user, the server device comprising:
an instructing unit that instructs the advertisement submitter terminal to display a search screen to allow the advertisement submitter to search a plurality of articles for an article related to the advertisement;
a search word receiving unit that receives a search word input to the search screen by the advertisement submitter;
a searching unit that searches the plurality of articles for a plurality of candidate articles on the basis of the search word;
a transmitting unit that transmits information specifying the plurality of candidate articles searched for to the advertisement submitter terminal, to cause the candidate articles to be displayed on the advertisement submitter terminal;
a receiving unit that receives, from the advertisement submitter terminal, information specifying at least one candidate article selected from the plurality of candidate articles displayed on the advertisement submitter terminal; and
a sending unit that sends the advertisement to the user terminal when an article similar to the selected candidate article is read in the user terminal, to cause the advertisement to be displayed on the user terminal together with the similar article.

5. The server device according to claim 4, wherein:
the plurality of candidate articles are each stored in a storage unit in an identifiable state, and
when the receiving unit receives the information specifying the selected candidate article from the advertisement submitter terminal, the storage unit stores an article corresponding to the information specifying the selected candidate article and the advertisement in association with each other.

6. The server device according to claim 4, further comprising a similar article searching unit that searches for an article similar to a prescribed candidate article among selected candidate articles.

7. The server device according to claim 4, wherein the transmitting unit transmits to the advertisement submitter terminal the information specifying the candidate articles such that articles corresponding to the information specifying the candidate articles are displayed on the advertisement submitter terminal in an order of similarity to the search word, in an order of view frequency, or in a descending order of posted date and time.

8. The server device according to claim 4, further comprising a unit that causes keywords indicating content of the plurality of candidate articles searched for by the searching unit to appear on the screen of the advertisement submitter terminal for display.

9. A server device in an advertisement providing system including an advertisement submitter terminal for an advertisement submitter to input an advertisement, a user terminal for a user to read articles, wherein the server device causes an advertisement to be displayed on the user terminal together with an article read by the user, the server device comprising:
a transmitting unit that transmits information specifying a plurality of candidate articles to the advertisement submitter terminal, to cause the candidate articles to be displayed on the advertisement submitter terminal;
a receiving unit that receives from the advertisement submitter terminal information specifying at least one candidate article selected from the plurality of candidate articles displayed on the advertisement submitter terminal; and
a sending unit that sends the advertisement to the user terminal when the selected candidate article is read in the user terminal, to cause the advertisement to be displayed on the user terminal together with the article.
